(19) United States
(12) Patent Application Publication
(10) Pub. No.: US 2005/0228617 A1
(43) Pub. Date: Oct. 13, 2005

(54) Methods and systems for tracking probe use

(76) Inventors: Scott Kerwin, Scottsdale, AZ (US); Atsushi Morimoto, Phoenix, AZ (US)

Correspondence Address: Dean D. Small;Armstrong Teasdale LLP, Suite 2600, One Metropolitan Square, St. Louis, MO, 63102, US

(21) Appl. No.: 10/817,137

(22) Filed: Apr. 2, 2004

(51) Int. Cl. G06F 17/40

(52) U.S. Cl. 702/187; 73/596

(57) ABSTRACT

Methods and systems for tracking use of an ultrasound probe are provided. The method includes storing tracking information within an ultrasound probe and accessing the stored tracking information within the ultrasound probe.

### BACKGROUND OF THE INVENTION

This invention relates generally to ultrasound systems and, more particularly, to methods and systems for tracking probe use in ultrasound systems.

Ultrasound systems typically include ultrasound scanning devices, such as, ultrasound probes having different transducers that allow for performing various different ultrasound scans (e.g., different imaging of a volume or body). These ultrasound probes are typically removably connectable to the ultrasound system. Additionally, different modes of operation are typically available, such as, for example, amplitude mode (A-mode), brightness mode (B-mode), power Doppler mode, color imaging mode, etc.

Ultrasound probes have a useful life, which may be specified, for example, as the number of expected hours of operational use for that probe. However, the life of the ultrasound probe may extend beyond this period or may be shortened, for example, due to a failure. It is typically difficult, if not impossible, to determine the source of a failure of an ultrasound probe, which may be caused, for example, by excessive use or a manufacturing/design problem. Thus, for example, when an ultrasound probe is returned from a customer to a manufacturer or seller before the expected time (e.g., shorten than the expected useful life), it is difficult and often impossible to determine the cause of the shorten life of the ultrasound probe.

It is know to contact the users of the ultrasound probe or conduct surveys in an attempt to determine the usage level of the probe in order to determine the cause of the shortened life. However, this process is typically informal and not structured, leading to incomplete or inaccurate results. Thus, it is very difficult or impossible to determine the cause of the shortened life of the ultrasound probe, thereby making it difficult or impossible to address and/or correct any problems that may exist with the ultrasound probe (e.g., manufacturing or design problems).

### BRIEF DESCRIPTION OF THE INVENTION

In one embodiment, a method for tracking use of an ultrasound probe is provided. The method includes storing tracking information within an ultrasound probe and accessing the stored tracking information within the ultrasound probe.

In another embodiment, an ultrasound system is provided. The ultrasound system includes an ultrasound scanner and an ultrasound probe removably connectable to the ultrasound scanner, with the ultrasound probe having a memory for storing tracking information.

### BRIEF DESCRIPTION OF THE DRAWINGS

FIG. 1 is a block diagram of an ultrasound system in accordance with an exemplary embodiment of the present invention.

FIG. 2 is a block diagram of an ultrasound system in accordance with another exemplary embodiment of the present invention.

FIG. 3 is a perspective view of an image of an object acquired by the systems of FIGS. 1 and 2 in accordance with an exemplary embodiment of the present invention.

FIG. 4 is a simplified block diagram illustrating an ultrasound system for tracking probe use in accordance with an exemplary embodiment of the present invention.

FIG. 5 is a flowchart showing a process for tracking probe use in accordance with an exemplary embodiment of the present invention.

### DETAILED DESCRIPTION OF THE INVENTION

Exemplary embodiments of ultrasound systems and methods for tracking probe use are described in detail below. In particular, a detailed description of exemplary ultrasound systems will first be provided followed by a detailed description of various embodiments of methods and systems for tracking probe use. It should be noted that the various embodiments of the present invention may be implemented in connection with different types of medical imaging systems having removably connectable scanning and/or imaging elements (e.g., probes).

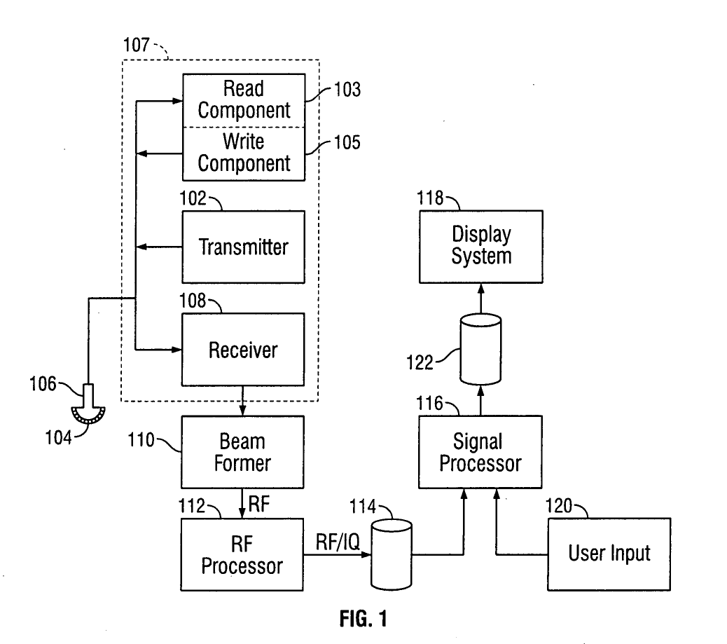

FIG. 1 illustrates a block diagram of an exemplary embodiment of an ultrasound system 100 that may be used, for example, to acquire and process ultrasonic images. The ultrasound system 100 includes a probe interface 107 having a transmitter 102 that drives an array of elements 104 (e.g., piezoelectric crystals) within or formed as part of a transducer 106 to emit pulsed ultrasonic signals into a body or volume. A variety of geometries may be used and one or more transducers 106 may be provided as part of a probe (not shown). The pulsed ultrasonic signals are back-scattered from density interfaces and/or structures, for example, in a body, like blood cells or muscular tissue, to produce echoes that return to the elements 104. The echoes are received by a receiver 108 within the probe interface 107 and provided to a beamformer 110. The beamformer performs beamforming on the received echoes and outputs an RF signal. The RF signal is then processed by an RF processor 112. The RF processor 112 may include a complex demodulator (not shown) that demodulates the RF signal to form IQ data pairs representative of the echo signals. The RF or IQ signal data then may be routed directly to an RF/IQ buffer 114 for storage (e.g., temporary storage). The probe interface 107 also includes a read component 103 and a write component 105 for accessing (e.g., reading from and writing to) a memory within a probe connected to the ultrasound system 100.

The ultrasound system 100 also includes a signal processor 116 to process the acquired ultrasound information (i.e., RF signal data or IQ data pairs) and prepare frames of ultrasound information for display on a display system 118. The signal processor 116 is adapted to perform one or more processing operations according to a plurality of selectable ultrasound modalities on the acquired ultrasound information. Acquired ultrasound information may be processed in real-time during a scanning session as the echo signals are received. Additionally or alternatively, the ultrasound information may be stored temporarily in the RF/IQ buffer 114 during a scanning session and processed in less than real-time in a live or off-line operation.

The ultrasound system 100 may continuously acquire ultrasound information at a frame rate that exceeds fifty frames per second, which is the approximate perception rate of the human eye. The acquired ultrasound information is displayed on the display system 118 at a slower frame-rate. An image buffer 122 may be included for storing processed frames of acquired ultrasound information that are not scheduled to be displayed immediately. In an exemplary embodiment, the image buffer 122 is of sufficient capacity to store at least several seconds of frames of ultrasound information. The frames of ultrasound information may be stored in a manner to facilitate retrieval thereof according to their order or time of acquisition. The image buffer 122 may comprise any known data storage medium.

A user input device 120 may be used to control operation of the ultrasound system 100. The user input device 120 may be any suitable device and/or user interface for receiving user inputs to control, for example, the type of scan or type of transducer to be used in a scan and/or to begin or end scanning operation with a probe.

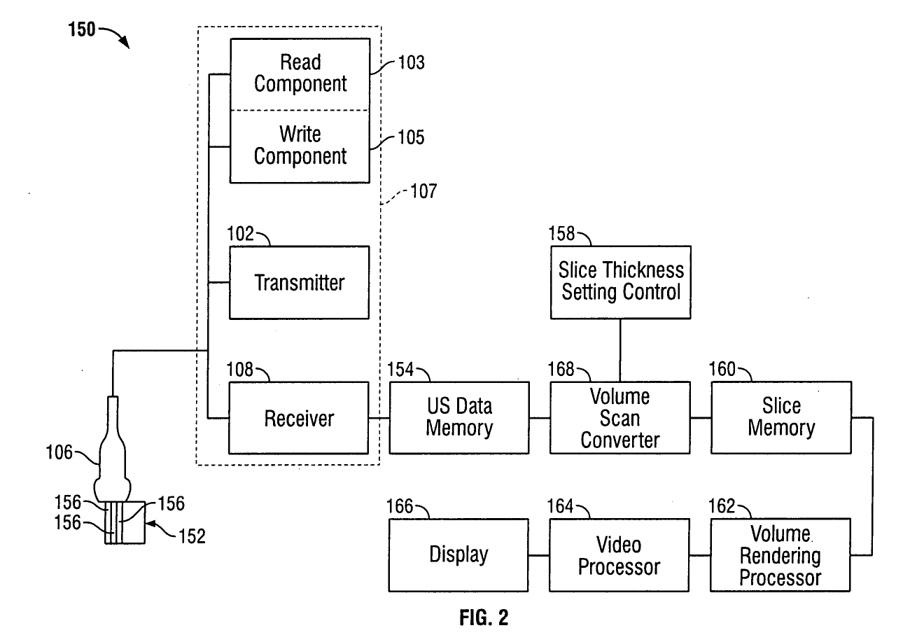

FIG. 2 illustrates a block diagram of another exemplary embodiment of an ultrasound system 150 that may be used, for example, to acquire and process ultrasonic images. The ultrasound system 150 includes the transducer 106, which in various embodiments is embodied within a probe, in communication with the probe interface 107 having the transmitter 102 and receiver 108. The transducer 106 transmits ultrasonic pulses and receives echoes from structures inside a scanned ultrasound volume 152. A memory 154 stores ultrasound data from the receiver 108 derived from the scanned ultrasound volume 152. The scanned ultrasound volume 152 may be obtained by various techniques, including, for example, 3D scanning, real-time 3D imaging, volume scanning, scanning with transducers having positioning sensors, freehand scanning using a Voxel correlation technique, 2D scanning or scanning with a matrix of array transducers, among others. The probe interface 107 also includes a read component 103 and a write component 105 for accessing (e.g., reading from and writing to) a memory within a probe connected to the ultrasound system 100.

The transducer 106 is moved, such as along a linear or arcuate path, while scanning a region of interest (ROI). At each linear or arcuate position, the transducer 106 obtains a plurality of scan planes 156. The scan planes 156 are collected for a thickness, such as from a group or set of adjacent scan planes 156. The scan planes 156 are stored in the memory 154, and then provided to a volume scan converter 168. In some exemplary embodiments, the transducer 106 may obtain lines instead of the scan planes 156, with the memory 154 storing lines obtained by the transducer 106 rather than the scan planes 156. The volume scan converter 168 receives a slice thickness setting from a slice thickness setting control 158, which identifies the thickness of a slice to be created from the scan planes 156. The volume scan converter 168 creates a data slice from multiple adjacent scan planes 156. The number of adjacent scan planes 156 that are obtained to form each data slice is dependent upon the thickness selected by the slice thickness setting control 158. The data slice is stored in a slice memory 160 and accessed by a volume rendering processor 162. The volume rendering processor 162 performs volume rendering upon the data slice. The output of the volume rendering processor 162 is provided to a video processor 164 that processes the volume rendered data slice for display on a display 166.

It should be noted that the position of each echo signal sample (Voxel) is defined in terms of geometrical accuracy (i.e., the distance from one Voxel to the next) and one or more ultrasonic responses (and derived values from the ultrasonic response). Suitable ultrasonic responses include gray scale values, color flow values, and angio or power Doppler information. It also should be noted that the ultrasound system 150 may include a user input or user interface for controlling the operation of the ultrasound system 150.

Further, it should be noted that the ultrasound systems 100 and 150 may include additional or different components. For example, the ultrasound system 150 may include a user interface or user input 120 (shown in FIG. 1) to control the operation of the ultrasound system 150, including, to control the input of patient data, scan parameters, a change of scan mode, and the like. Additionally, the ultrasound systems 100 and 150 may be modified. For example, the probe interface 107 may include only the read component 103 and write component 105 with the transmitter 102 and receiver 108 provided separate from the probe interface 107.

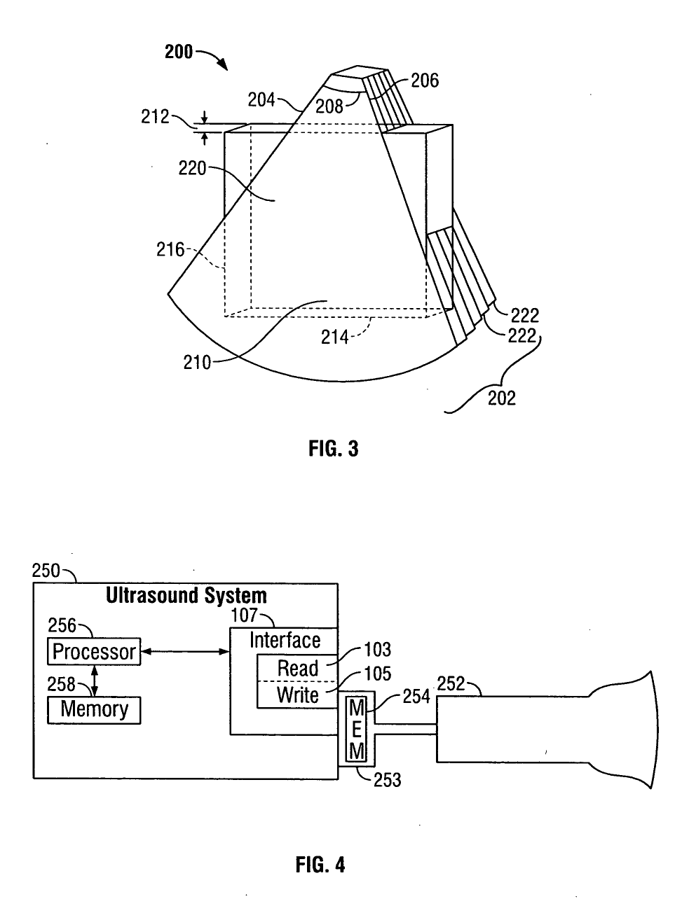

FIG. 3 illustrates an exemplary image of an object 200 that may be acquired by the ultrasound systems 100 and 150. It should be noted that although the image acquired is a volume, different images may be acquired, such as, for example, 2D images. The object 200 includes a volume 202 defined by a plurality of sector shaped cross-sections with radial borders 204 and 206 diverging from one another at an angle 208. The transducer 106 (shown in FIGS. 1 and 2) electronically focuses and directs ultrasound firings longitudinally to scan along adjacent scan lines in each scan plane 156 (shown in FIG. 2) and electronically or mechanically focuses and directs ultrasound firings laterally to scan adjacent scan planes 156. The scan planes 156 obtained by the transducer 106, and as illustrated in FIG. 1, are stored in the memory 154 and are scan converted from spherical to Cartesian coordinates by the volume scan converter 168. A volume comprising multiple scan planes 156 is output from the volume scan converter 168 and stored in the slice memory 160 as a rendering region 210. The rendering region 210 in the slice memory 160 is formed from multiple adjacent scan planes 156.

The rendering region 210 may be defined in size by an operator using a user interface or input to have a slice thickness 212, width 214 and height 216. The volume scan converter 168 (shown in FIG. 2) may be controlled by the slice thickness setting control 158 (shown in FIG. 2) to adjust the thickness parameter of the slice to form a rendering region 210 of the desired thickness. The rendering region 210 defines the portion of the scanned ultrasound volume 152 that is volume rendered. The volume rendering processor 162 accesses the slice memory 160 and renders along the slice thickness 212 of the rendering region 210.

Referring now to FIGS. 1 and 2, during operation, a slice having a pre-defined, substantially constant thickness (also referred to as the rendering region 210) is determined by the slice thickness setting control 158 and is processed in the volume scan converter 168. The echo data representing the rendering region 210 (shown in FIG. 3) may be stored in the slice memory 160. Predefined thicknesses between about 2 mm and about 20 mm are typical, however, thicknesses less than about 2 mm or greater than about 20 mm may also be suitable depending on the application and the size of the area to be scanned. The slice thickness setting control 158 may include a control member, such as a rotatable knob with discrete or continuous thickness settings.

The volume rendering processor 162 projects the rendering region 210 onto an image portion 220 of an image plane(s) 222 (shown in FIG. 3). Following processing in the volume rendering processor 162, pixel data in the image portion 220 may be processed by the video processor 164 and then displayed on the display 166. The rendering region 210 may be located at any position and oriented at any direction within the volume 202. In some situations, depending on the size of the region being scanned, it may be advantageous for the rendering region 210 to be only a small portion of the volume 202. It should be noted that the object 200 acquired may have different characteristics and/or configurations (e.g., 2D or 3D).

FIG. 4 illustrates a simplified block diagram of an ultrasound system 250 that may used for tracking probe use in accordance with various embodiments of the present invention. The ultrasound system 250 may include the component parts of ultrasound system 100 or 150 as described in more detail herein. In general, the ultrasound system includes the probe interface 107 having the read component 103 and write component 105 for communicating with an ultrasound probe 252 removably connected to the ultrasound system 250. The communication may be provided, for example, using an I²C protocol as is known and the probe interface 107 may comprise a transceiver as is known for providing the bi-directional communication. Specifically, the ultrasound probe includes a connector 253 for removable connection with the ultrasound system 250. The probe interface 107 within the ultrasound system 250 access a memory 254 of the ultrasound probe 252 to track probe use as described in more detail herein. The read component 103 reads information from the memory 254 and the write component 105 writes information to the memory 254. The memory 254 may be any suitable memory storage device such as, for example, any non-volatile re-programmable memory, including, but not limited to, a cache memory, an Erasable Programmable Read-Only Memory (EPROM) and/or an Electronically Erasable Programmable Read-Only Memory (EEPROM), among others.

It should be noted that although in the exemplary embodiment shown in FIG. 4, the memory 254 is located within the connector 253 of the ultrasound probe 252, the memory 254 may be provided at different locations of the ultrasound probe 252 as desired or needed (e.g., based upon system or probe configurations), such as within the ultrasound probe 252.

It further should be noted that the ultrasound probe 252 may include more than one memory 254, for example, an EPROM to store probe identification information (e.g., eight bits of identification information) and tracking information, and a cache memory for storing operational parameter information for use in controlling the operation of the probe 252 (e.g., for controlling dynamic beamforming). The ultrasound system 250 may, for example, use the identification information to identify the type of probe 252 connected to the ultrasound system 250 for controlling the operation of the ultrasound probe 252 using stored information (e.g., frequency, voltage and signal processing information) relating to the ultrasound probe 252. Additionally, the ultrasound probe 252 may include additional components, such as, for example, a thermistor that may be used for tracking temperature information relating to the ultrasound probe 252 as described herein.

The ultrasound system 250 further includes a processor 256 for controlling operation of the ultrasound system 250. The processor may include some or all of the processing component parts of the ultrasound systems 100 and 150 as described herein. The ultrasound system 250 also includes a memory 258, which may be used for temporarily or permanently storing tracking or other information from the memory 254 of the ultrasound probe 252 and as described in more detail herein.

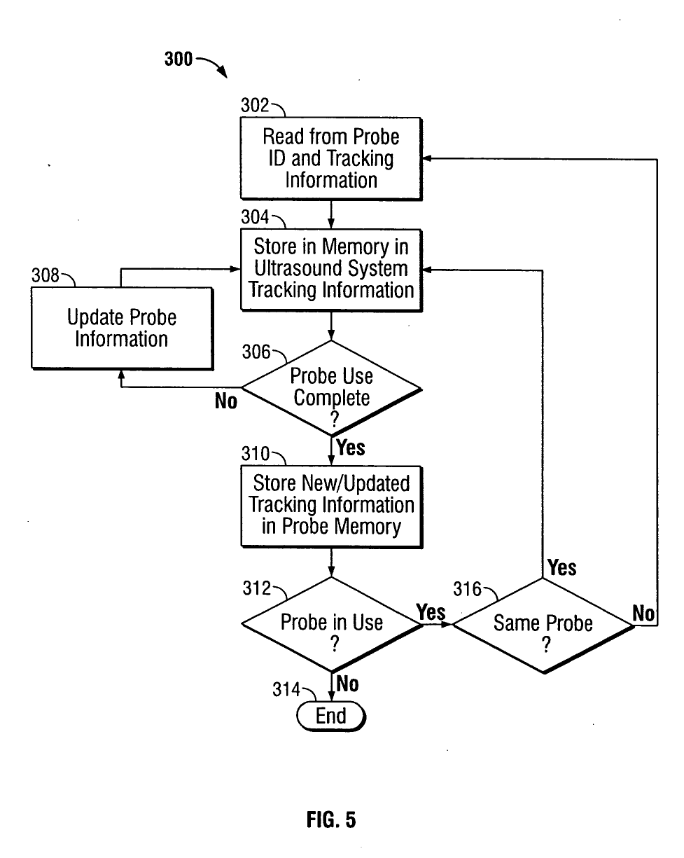

A process 300 for tracking probe use in accordance with exemplary embodiments of the present invention is shown in FIG. 5. Specifically, once an ultrasound probe is connected to an ultrasound system (e.g., the ultrasound system 250 shown in FIG. 4) information is accessed and read from the probe (e.g., the probe 252 shown in FIG. 4) at 302. This information may include, for example, probe identification information identifying the type of probe connected to the ultrasound system and tracking information. The tracking information may include, but is not limited to, duration of use information, which may be continuous use information and/or information relating to individual scans with the probe, length of time between scans information, probe usage pattern information (e.g., number of times the probe is used each day and length of use each time), mode of operation information, temperature information based upon thermistor measurements, probe shut down information due to excessive temperature conditions, probe temperature duration information, among other information. In general, the tracking information may include any information useful for tracking the operation of the probe and which may be used to analyze the use of a particular probe.

The information is stored within a memory of the probe, such as the memory 254 shown in FIG. 4, and once accessed, is then also stored in a memory of the ultrasound system at 304, such as the memory 258 shown in FIG. 4. In one embodiment this information includes at least the tracking information. The usage of the probe is then monitored, for example, the scan time is monitored, and a determination is made at 306 as to whether the probe use is complete (e.g., whether a current scan is complete). If the probe use is not complete, then at 308 the information is updated, which may include, for example, updating the tracking information stored in the memory of the ultrasound system. For example, the current use time for the probe may be added to the prior use time for the probe. Additionally, this updated information may be provided (e.g., written) to the probe, and in particular, to the probe memory. However, it should be noted that this information may be updated only once during a scan, at the end of the scan, or more than once, for example, periodically during the scan.

If a determination is made at 306 that the probe use is complete, then at 310, new and/or updated information, including the tracking information, is stored in the probe, for example in the probe memory. This updated information may include, for example, updated probe usage time information comprising prior probe usage time information and time usage information for the new scan that was performed (e.g., adding new scan time usage information to prior or cumulative time usage information). Any updated information as described herein for tracking probe use may be stored at 310, for example, mode of operation scan information relating to the scan performed and/or temperature information. Further, in another embodiment of the present invention, the updated information may be stored periodically within the probe and/or ultrasound system.

In one exemplary embodiment, the information is accessed at 302 and stored at 310 within a specific address location in the memory within the probe. A separate address location may be provided for the different information. Additionally, the updated information may be stored within the memory in the ultrasound system.

A determination is then made at 312 as to whether a probe is again in use. If a probe is not use, then the process ends at 314. Information from an ultrasound probe is not accessed again at 302 until an ultrasound probe is connected to and/or activated from the ultrasound system. However, in one embodiment, the duration of time between probe uses (e.g., time between when a probe is removed and then reconnected to the ultrasound system) is monitored, for example, using a timer within the ultrasound system.

If a determination is made at 312 that a probe is in use, then at 316 a determination is made as to whether the ultrasound probe is the same ultrasound probe from the immediately preceding scan. If the ultrasound probe is the same probe, then information, for example, tracking information is again stored in the ultrasound system at 304. If the ultrasound probe is not the same probe, then information, including, for example, identification information and tracking information are again accessed from the ultrasound probe at 302 (e.g., read from the memory of the new probe).

It should be noted that the component parts of the ultrasound system 250 may be constructed and/or provided as desired or needed, for example, based upon the scanning to be performed. Thus, different component parts may implemented to perform the various operations and functions as described herein. Further, the process 300 may be modified to track any type of information as desired or needed, particularly information useful for analyzing the specifics of the operation of a probe during its operational life.

The ultrasound systems and the methods described herein may be used to track any information as desired or needed relating to the use of probes in connection with an ultrasound systems. Further, the method may be used to track information in connection with any medical imaging system having removably connectable scanning and/or imaging members.

Thus, various embodiments of the present invention allow for tracking the operating specifics, conditions and patterns of a probe. This tracking may allow, for example, for a determination of the cause of a shortened probe life (e.g., if the cause is a result of excessive or improper use).

While the invention has been described in terms of various specific embodiments, those skilled in the art will recognize that the invention can be practiced with modification within the spirit and scope of the claims.

1. A method for tracking use of an ultrasound probe, said method comprising:
storing tracking information within an ultrasound probe; and
accessing the stored tracking information within the ultrasound probe.

2. A method in accordance with claim 1 further comprising:
updating the tracking information based on use of the ultrasound probe; and
storing the updated tracking information within the ultrasound probe.

3. A method in accordance with claim 1 wherein the tracking information comprises duration of use information.

4. A method in accordance with claim 1 wherein the tracking information comprises duration of use information, the duration of use information including at least one of continuous use information, individual scan session use information, duration of time between scans information and usage pattern information.

5. A method in accordance with claim 1 wherein the tracking information comprises mode of operation information.

6. A method in accordance with claim 1 wherein the tracking information comprises probe temperature information.

7. A method in accordance with claim 1 wherein the storing is performed upon powering off the ultrasound probe.

8. A method in accordance with claim 1 wherein the storing is performed periodically.

9. A method in accordance with claim 1 further comprising storing the tracking information within an ultrasound system in connection with the ultrasound probe.

10. A method in accordance with claim 1 wherein the storing comprises storing the tracking information to a memory within the ultrasound probe.

11. A method in accordance with claim 1 wherein the storing comprises storing the tracking information to a predetermined address location within a memory within the ultrasound probe.

12. A method in accordance with claim 1 wherein the ultrasound probe comprises a non-volatile reprogrammable memory and wherein the storing comprises storing the tracking information to the non-volatile reprogrammable memory.

13. A method in accordance with claim 1 wherein the accessing is performed upon the ultrasound probe being connected to an ultrasound system.

14. A method in accordance with claim 1 wherein the accessing further comprises accessing probe identification information stored within the ultrasound probe.

15. A method in accordance with claim 2 further comprising storing the updated tracking information within an ultrasound system connected to the ultrasound probe.

16. A method in accordance with claim 2 further comprising determining a use time period of the ultrasound probe for updating the tracking information based upon a time period when the ultrasound probe is powered on.

17. A method in accordance with claim 2 further comprising determining a use time period of the ultrasound probe for updating the tracking information based upon a time period when the ultrasound probe is scanning.

18. A method in accordance with claim 2 wherein the updated tracking information comprises cumulative tracking information and current use information.

19. A method in accordance with claim 1 wherein the tracking information comprises prior probe use information.

20. A method for tracking use of an ultrasound probe, said method comprising:
determining when an ultrasound probe is connected to an ultrasound system;
accessing probe scan time information and probe identification information stored within the ultrasound probe when a determination is made that the ultrasound probe is connected to the ultrasound system;
storing the accessed probe scan time information and probe identification information within the ultrasound system;
measuring a current scan time for the ultrasound probe;
updating the scan time information with the current scan time; and
storing the updated scan time information within the ultrasound probe.

21. A method in accordance with claim 20 wherein the storing of the updated scan time information is performed upon one of powering off the ultrasound probe and ending an ultrasound scan.

22. A method in accordance with claim 20 wherein the storing of the updated scan time information is performed periodically during a current scan and further comprising storing the updated scan time information within the ultrasound system.

23. A method in accordance with claim 20 wherein the information is accessed from and stored to a non-volatile reprogrammable memory within the ultrasound probe.

24. An ultrasound system comprising:
an ultrasound scanner; and
an ultrasound probe removably connectable to the ultrasound scanner, the ultrasound probe having a memory for storing tracking information.

25. An ultrasound system according to claim 24 wherein the memory is configured to be accessed by the ultrasound scanner.

26. An ultrasound system according to claim 24 wherein the ultrasound scanner comprises a probe interface for reading information from and writing information to the memory within the ultrasound probe.

27. An ultrasound system according to claim 24 wherein the tracking information comprises at least one of duration of use information, usage pattern information, mode of operation information, temperature information and temperature power off information.
